(19) United States
(12) Patent Application Publication
(10) Pub. No.: US 2019/0337493 A1
(43) Pub. Date: Nov. 7, 2019

(54) Device and Means for Jacking a Vehicle

(71) Applicant: Darrell Wade Wilkerson, Coppell, TX (US)

(72) Inventor: Darrell Wade Wilkerson, Coppell, TX (US)

(21) Appl. No.: 15/969,784

(22) Filed: May 3, 2018

(51) Int. Cl. B60S 9/04; B60D 1/66

(52) U.S. Cl. CPC B60S 9/04; B60D 1/66

(57) ABSTRACT

A device and method for lifting (hereinafter referred to as “jacking”) a vehicle is disclosed. The device engages with the vehicle and consists of a plurality of legs of differing lengths that are each free to rotate independently of one another and about an axis or a plurality of axes (hereinafter referred to as the “pivot axis” or the “pivot axes”). Each leg has one end (hereinafter referred to as the “pivotable end”) that is oriented more closely to the pivot axis and an opposite end (hereinafter referred to as the “free end”) that is oriented more away from the pivot axis. Additionally, each leg has a fully retracted or stowed position and a fully extended position. When it is desired to jack the vehicle, the legs are each allowed to freely and independently rotate out of the stowed position and about the pivot axis or axes allowing each free end to come into contact with a ground plane (such as the ground) or some other grounded surface (hereinafter referred to as the “ground plane”) against which the vehicle will be jacked. The legs are arranged such that at least one leg (hereinafter referred to as the “engaged leg”) will always be positioned at a sufficiently steep angle (hereinafter referred to as the “grip angle”) to the ground plane such that when the vehicle is moved along the ground plane, sufficient force is imparted on the ground plane through the engaged leg such that friction between the free end and the ground plane will prevent the free end from sliding relative to the ground plane and will cause the engaged leg to rotate about its pivot axis as the vehicle moves along the ground plane causing a lifting motion to be imparted on the vehicle by the engaged leg. As this first engaged leg is rotated about its pivot axis and becomes oriented more perpendicular to the ground plane to its fully extended position, a second, longer leg becomes oriented at its grip angle such that when the vehicle continues to move along the ground plane, sufficient force is imparted on the ground plane through the second, now engaged, leg such that friction between the free end and the ground plane will prevent the free end from sliding relative to the ground plane and will cause the engaged leg to rotate about its pivot axis as the vehicle moves along the ground plane causing a continuing lifting motion to be imparted on the vehicle by the engaged leg. This arrangement and orientation of legs continues and this process continues through as many legs as is required to sufficiently jack the vehicle to the desired height relative to the ground plane. As each engaged leg becomes oriented more perpendicular to the ground plane to its fully extended position, a subsequent leg then becomes the engaged leg as it becomes positioned at its grip angle such that when the vehicle is moved along the ground plane, sufficient force is imparted on the ground plane through the engaged leg such that friction between the free end and the ground plane will prevent the free end from sliding relative to the ground plane and will cause the engaged leg to rotate about its pivot axis as the vehicle moves along the ground plane causing a lifting motion to be imparted on the vehicle by the engaged leg.

### SUMMARY

An improved device and method for lifting or jacking a vehicle is provided. In one embodiment, the device consists of a plurality of legs that are mounted directly to the axle(s) of a vehicle. The legs vary in length and are free to rotate about an axis (pivot axis) from a fully retracted or stowed position to a fully extended position. When not in use, the legs are stored in the stowed position. When needed for lifting (jacking) the vehicle, the legs are released from the stowed position and allowed to rotate about their pivot axis until they come into contact with the ground. The shortest leg length is determined by the vehicle wheel diameter, without a tire, and the longest leg length is determined by the vehicle fully-inflated tire diameter. The shortest leg length is sized such that if the vehicle were resting on the rim of the vehicle wheel, the angle of the leg relative to the ground (leg angle) is steep enough that as the vehicle is moved along the ground plane, sufficient force is imparted on the leg such that the static friction between the leg and the ground surface prevents the leg from sliding relative to the ground. This angle is referred to as the “grip angle” and in this condition, the leg is said to be “engaged”. Once engaged, a jacking force is imparted on the axle which lifts (jacks) the vehicle. As the vehicle continues to move along the ground plane, the engaged leg continues to rotate about its pivot axis and continues to lift (jack) the vehicle as it rotates. The longest leg length is sized such that if the vehicle were fully lifted (jacked) with the longest leg in its fully extended position, there is sufficient ground clearance to facilitate removal and installation of the vehicle wheel having a fully inflated tire. Additionally, there is a plurality of legs of varying lengths, said lengths varying between the shortest leg length and the longest leg length such that as the vehicle is moved along the ground plane during the vehicle jacking process, at least one leg is always engaged. To jack the vehicle, simply release the legs from their stowed position which allows them to rotate about their pivot axis and come into contact with the ground causing the first leg to be positioned at a leg angle greater than or equal to its grip angle causing the leg to be engaged. Then, simply move the vehicle along the ground plane by pulling it forward or backing it up. As the vehicle continues to move along the ground plane, the engaged leg will continue to rotate, jacking the vehicle, until the leg reaches its fully extended position at which point the next leg reaches its grip angle, becomes engaged, and continues jacking the vehicle. This process continues progressively with each leg until the vehicle is completely jacked and the last leg (longest leg) is in its fully extended position. The device and method is extremely quick, easy and safe to use. Additional embodiments include but are not limited to; optional methods of attaching the device to the vehicle, optional locations for attaching the device to the vehicle, and optional means of causing the legs to rotate about their pivot axis.

### BACKGROUND

Although this “Background” is written primarily with references to trailers, other vehicle types can have the same or similar issues, hazards, and challenges with respect to lifting or jacking the vehicle. This “Background” is not intended to be limited to trailers, but is intended to encompass any vehicle that may have a need to be lifted or jacked.

Trailers can be very difficult and potentially dangerous to jack, especially when they are fully loaded. Additionally, many trailers are not designed to properly handle jacking loads that can be imparted on them during the jacking process. This can damage the trailer as well as present significant danger to someone that is working on or around a trailer while it is jacked.

The primary reason for this difficulty is that most trailers do not have an adequate jacking location that is sufficiently designed to engage a jack nor is it sufficiently designed to properly handle jacking loads. As a result, once jacked, there is potential for the trailer to be damaged or to fall off of the jack. Most trailers are not sufficiently designed or made for assured safety and proper load distribution while being jacked.

This difficulty presents real problems for anyone that uses a trailer. If a business uses a trailer to transport equipment and materials for their business, a flat tire can delay their progress for several hours. Not only is it a logistical problem for delivering equipment, goods and materials to the intended customer or job site, there is significant potential for damage to the trailer as well as the equipment, goods and materials being transported, not to mention the potential safety hazards and danger affecting the personnel responsible for fixing the flat tire while traffic speeds by. This not only costs the business money, it exposes their personnel to danger and causes delays in providing product and services to the customer. The same issues face an individual using a trailer for personal or recreational use. Not only is there potentially significant inconvenience to the individual, there is a real potential for damage to the trailer and anything being hauled by the trailer and the individual is exposed to the same hazards and dangers associated with trying to jack a trailer on the side of the road while traffic speeds by.

Another problem or issue facing trailers is the amount of time many trailers sit idle, especially when loaded. Trailers that haul heavy equipment sometimes sit long periods of time with equipment loaded on them. Boat trailers are another example of trailers that are likely to sit idle for long periods of time while loaded. This is hard on the tires and can cause them to slowly leak air and go flat. It can also lead to other types of tire problems such as sidewall damage and tire dry rot.

Finally, another problem or issue facing trailers is the potential for theft, especially if they are loaded with some type of valuable cargo or equipment. There are devices currently available to provide security against theft, but with each of them, once the security device has been destroyed and removed, the trailer can easily be hooked up to a vehicle and stolen.

There are multiple examples of prior art that have attempted to address some of these issues. Hampson discloses in U.S. Pat. No. 829,333 a jacking device that consists of a jacking leg and utilizes vehicle motion for actuation. There are many other examples of prior art that offer variations to this approach. King discloses in U.S. Pat. No. 3,652,056 a jacking device that also utilizes vehicle motion for actuation, but adds an additional leg to the jacking device. The King jacking device contains a starter leg and a main support leg joined by a flexible member such that the main support leg is controlled by the attitude of the starter leg. Although this approach improves upon other prior art devices that utilize vehicle motion for jack actuation, the King approach does not provide adequate jacking range to provide complete jacking of a trailer having a completely flat tire or a trailer having completely lost its tire, especially for trailers or vehicles with smaller diameter wheels and larger diameter tires. Additionally, the King approach requires the use of a flexible member in order to control the main jacking support leg. as well as the use of a jack frame for attaching the jacking device to the trailer. Bollinger discloses in U.S. Pat. No. 3,733,051 and Jacobson discloses in U.S. Pat. No. 5,215,289, jacking devices that mount either on the trailer axle or some other similarly oriented cross member on the trailer. Both of these approaches cantilever the jacking leg between its mounting position on the trailer and the trailer axle or cross member. This approach is susceptible to inducing high loads from the jacking leg member into the axle or cross member during the jacking of the trailer. As the vehicle is moved to provide the jacking force and once the trailer is fully jacked and the jacking leg is resting against the axle or cross member, any further movement of the vehicle will induce extremely high cantilever loads which will potentially damage the axle, trailer, or jacking device. There are multiple other prior art examples that utilize movement of the vehicle to actuate a single jacking leg member such that the trailer is lifted including; U.S. Pat. No. 9,494,275 B2, U.S. Pat. Nos. 6,053,477, 5,228,651, 3,951,383, 3,881,746, and 3,744,757. Colclasure discloses a different approach in U.S. Pat. No. 3,881,691 in which the jacking leg member is pulled into position by a cable or by some other means other than by movement of the vehicle. One common drawback of the above prior art examples is that they do not provide sufficient lateral support for the trailer during the jacking process. Especially for situations in which a heavily loaded trailer is sitting on a sideward incline, later loads will cause the trailer to move laterally, perpendicular to the trailer jacking motion direction. Without sufficient lateral support, the trailer can induce tremendous side loads on the prior art jacking devices that can damage the trailer or the jacking device and can be extremely dangerous. Additionally, the prior art does not provide for a means of providing varying jacking positions simultaneously on each side of the trailer to account for uneven terrain.

The disclosed invention addresses all of the above challenges, problems and issues associated with jacking a trailer or any other vehicle that needs to be jacked and addresses the shortcomings of the prior art. It also addresses the challenges, problems, and issues associated with leaving a trailer sitting for extended periods of time and it can provide additional security and theft protection. This invention will help reduce down time in the event of a flat and will help improve safety for those that are faced with having to jack a trailer on the side of the road.

### DETAILED DESCRIPTION OF THE PREFERRED EMBODIMENT

Although the described and illustrated embodiments have been in connection with lifting or jacking a trailer, it should be understood that the device is in no way limited to use with trailers. In fact, the device may be implemented to lift or jack virtually any vehicle type including automobiles, trucks, semi-tractor trailers, etc. and the device may be utilized to provide jacking or lifting of objects other than vehicles whether the objects have wheels or not.

Referring now to the figures wherein reference numbers and the components they designate are consistently held throughout the figures.

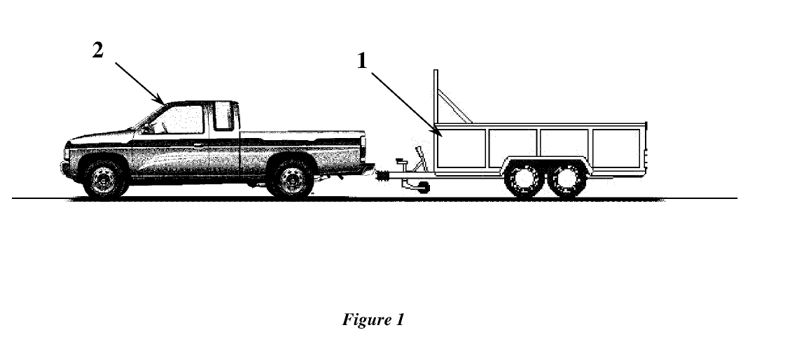

Referring now to FIG. 1 that shows a trailer 1 attached to a vehicle 2.

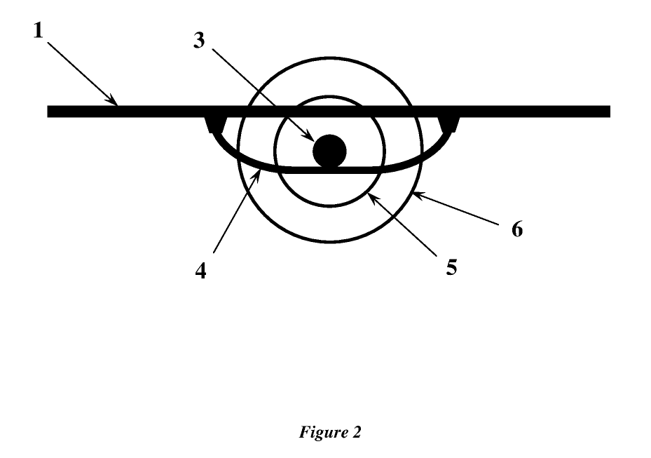

Referring now to FIG. 2 that shows an axle 3 that is supported by a suspension 4 that is attached to trailer 1. Referring still to FIG. 2 that shows a trailer wheel 5 that is attached to axle 3 and a trailer tire 6 mounted to the trailer wheel 5.

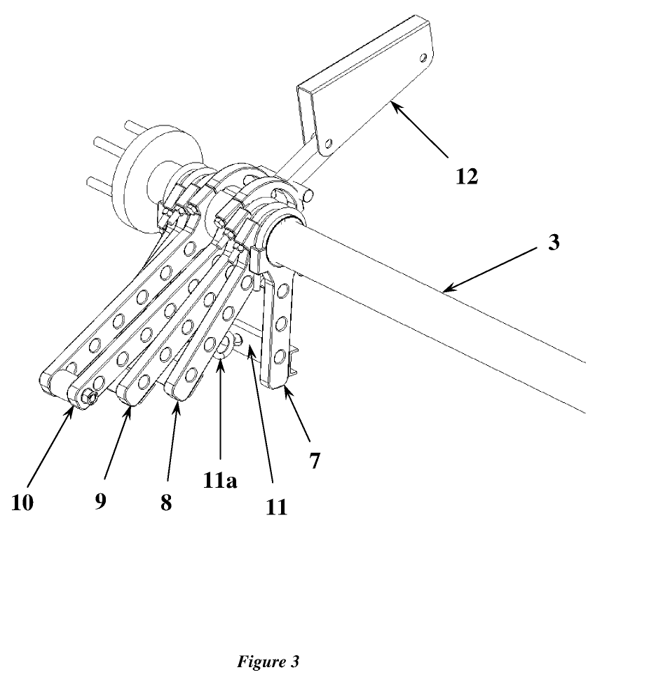

Referring now to FIG. 3 that shows one possible configuration of one embodiment that contains:
1. A plurality of leg members 7, 8, 9, and 10 that are mounted to axle 3 and are free to rotate about the axle 3 and free to rotate relative to and independent of one another,
2. a limiting member 11 attached to leg member 7 that limits to the rotation of leg members 7, 8, 9, and 10,
3. an anchor member 11A attached to limiting member 11 that limits the angle of rotation of leg member 7 about the axle 3, and
4. a locking member 12 that locks the leg members 7, 8, 9, and 10 in the extended position and prevents them from rotating about the axle 3.

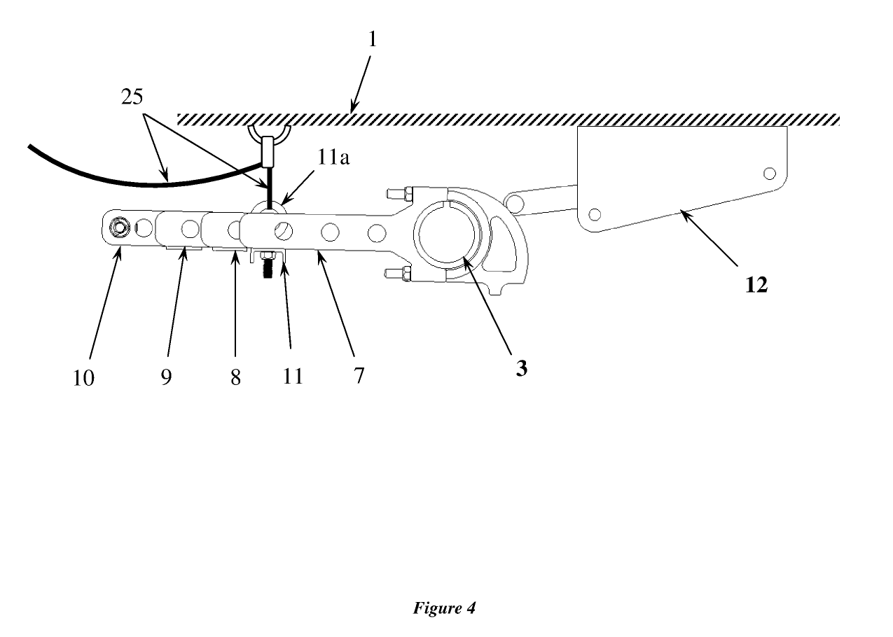

Referring now to FIG. 4 that shows the leg members 7, 8, 9, and 10 in a stowed position on trailer 1. Referring still to FIG. 4 that shows limiting member 11 supporting leg member 8, 9, and 10 and a limiting member 25 attached to the trailer 1 on one end and to anchor member 11A on another end. Referring still to FIG. 4 that shows axle 3 and locking member 12.

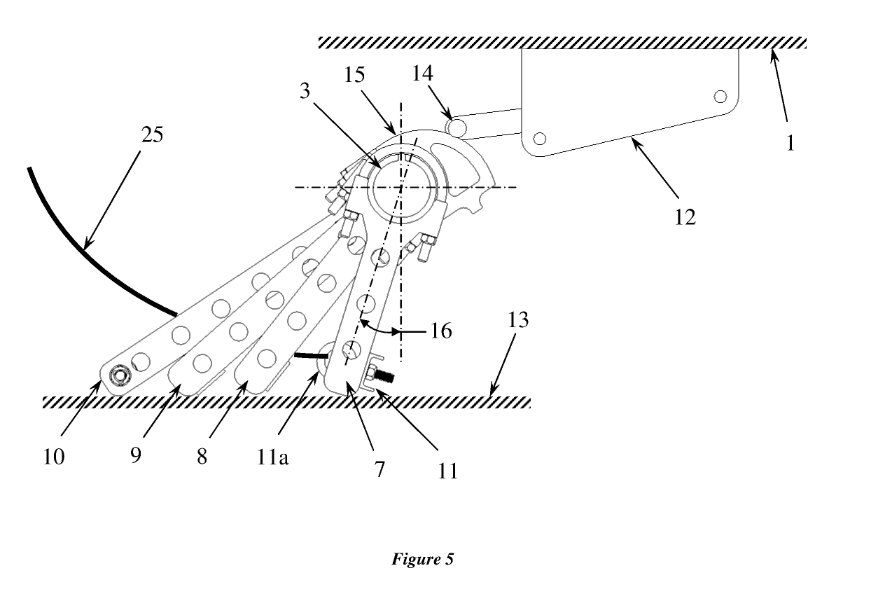

Referring now to FIG. 5 that shows the leg members 7, 8, 9, and 10 in their released position, having rotated about the axle 3 and making contact with the ground 13. Referring still to FIG. 5 that shows the position of leg member 7 relative to the axle 3 and the ground 13 (represented by angle 16) as well as the positions of leg members 8, 9, and 10 relative to the axle 3 and the ground 13. Referring still to FIG. 5 that shows limiting member 11 and anchor member 11A with a limiting member 25 attached to the trailer 1 on one end and to the anchor member 11A on another end. Referring still to FIG. 5 that shows a locking member 12 attached to trailer 1, locking member 12 having a locking bar 14 being guided by a cam 15 attached to leg member 10.

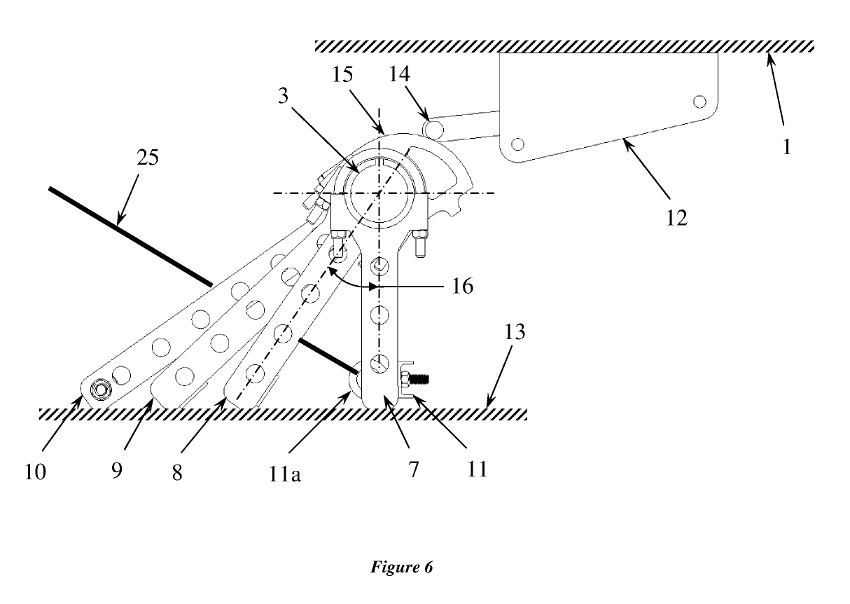

Referring now to FIG. 6 that shows the position of leg member 7 in the fully extended position with the limiting member 25 in its limiting position creating a limiting force between the trailer 1 and the limiting member 11 through anchor member 11A limiting the rotation of leg member 7 about axle 3. Referring still to FIG. 6 that shows the position of leg member 8 relative to the axle 3 and the ground 13 (represented by angle 16) as well as the positions of leg members 9 and 10 relative to the axle 3 and the ground 13. Referring still to FIG. 6 that shows a locking member 12 attached to trailer 1, locking member 12 having a locking bar 14 being guided by a cam 15 attached to leg member 10.

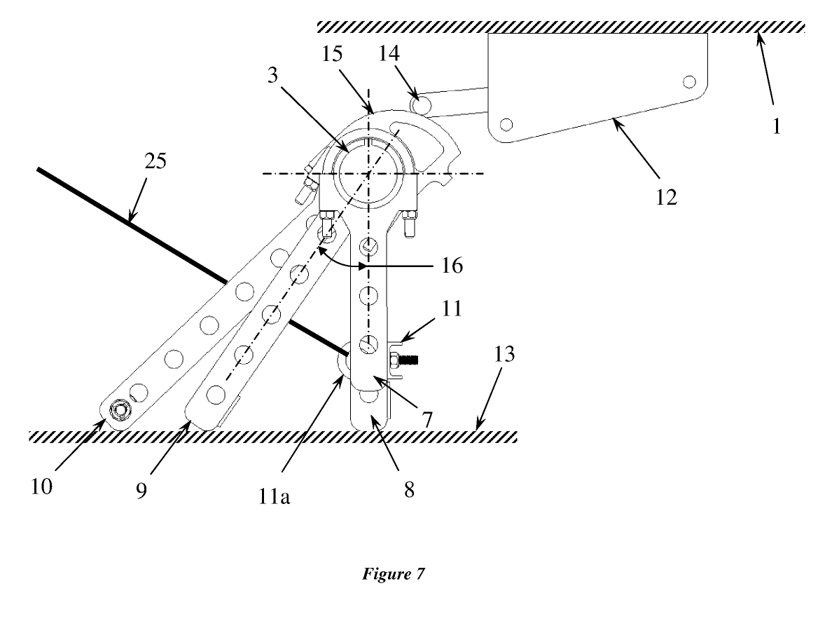

Referring now to FIG. 7 that shows the position of leg member 8 in the fully extended position against limiting member 11 that is now limiting the rotation of leg member 8 about the axle 3 with limiting member 25 still in its limiting position creating a limiting force between the trailer 1 and the limiting member 11 through anchor member 11A limiting the rotation of leg member 7 about the axle 3. Referring still to FIG. 7 that shows the position of leg member 9 relative to the axle 3 and the ground 13 (represented by angle 16) as well as the position of leg member 10 relative to the axle 3 and the ground 13. Referring still to FIG. 7 that shows a locking member 12 attached to trailer 1, locking member 12 having a locking bar 14 being guided by a cam 15 attached to leg member 10.

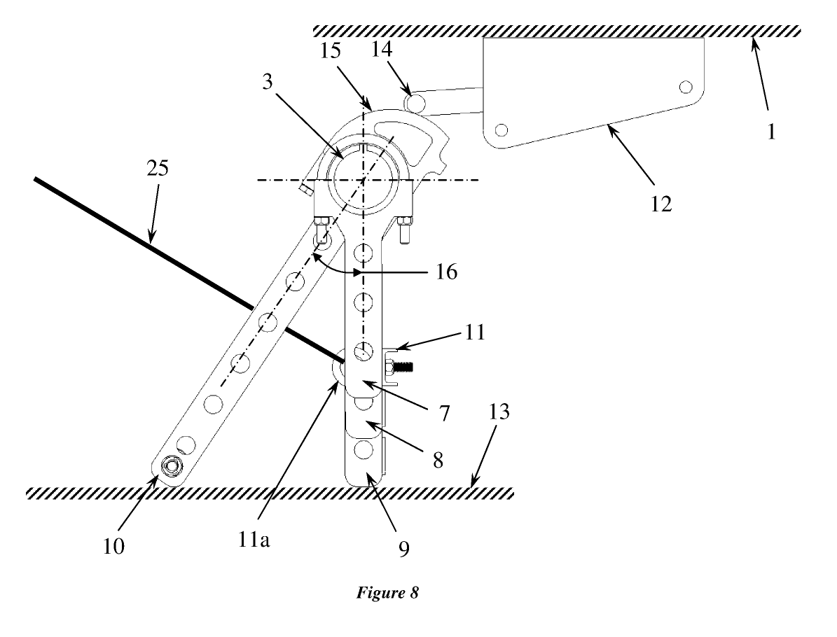

Referring now to FIG. 8 that shows the position of leg member 9 in the fully extended position against limiting member 11 that is now limiting the rotation of leg members 8 and 9 about the axle 3 with limiting member 25 still in its limiting position creating a limiting force between the trailer 1 and the limiting member 11 through anchor member 11A limiting the rotation of leg member 7 about the axle 3. Referring still to FIG. 8 that shows the position of leg member 10 relative to the axle 3 and the ground 13 (represented by angle 16). Referring still to FIG. 8 that shows a locking member 12 attached to trailer 1, locking member 12 having a locking bar 14 being guided by a cam 15 attached to leg member 10.

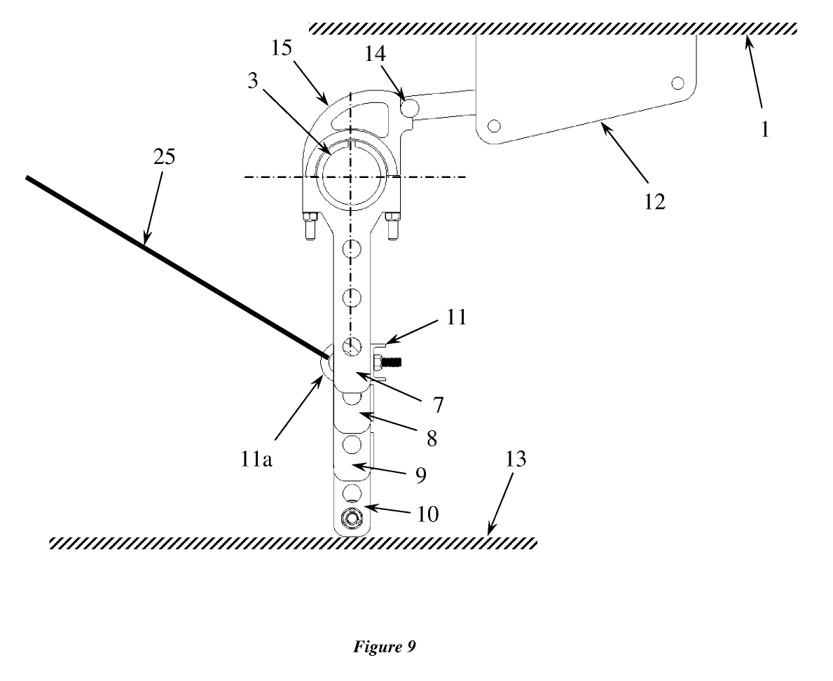

Referring now to FIG. 9 that shows the position of leg member 10 in the fully extended position against limiting member 11 that is now limiting the rotation of leg members 8, 9, and 10 about the axle 3 with limiting member 25 still in its limiting position creating a limiting force between the trailer 1 and the limiting member 11 through anchor member 11A limiting the rotation of leg member 7 about the axle 3. Referring still to FIG. 9 that shows the locking member 12 attached to trailer 1, locking member 12 having a locking bar 14 engaged with cam 15 on leg member 10 and locking leg members 7, 8, 9 and 10 in the extended position.

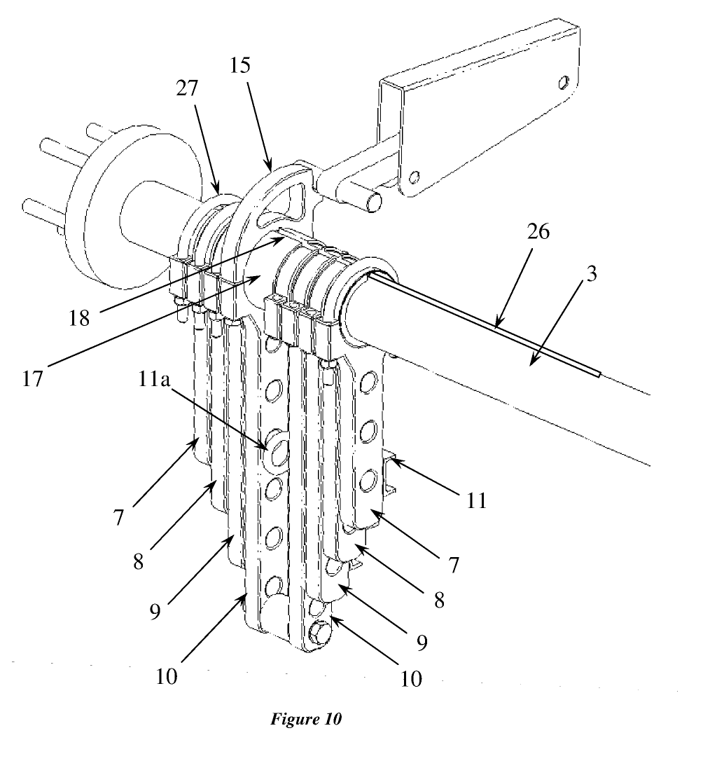

Referring now to FIG. 10 that shows one possible installation method for attaching one possible configuration of one embodiment to a trailer. Referring still to FIG. 10 that shows a trailer axle 3 and a sleeve member 17 containing bearing surfaces for leg members 7, 8, 9 and 10. Referring still to FIG. 10 that shows sleeve member 17 with a clearance path 18 for accommodation of hydraulic and electrical lines 26 that may be run along the axle 3. Referring still to FIG. 10 that shows U-Bolts 27 (some of which have been omitted for clarity) for attaching leg members 7, 8, and 9 around sleeve member 17 to axle 3. Referring still to FIG. 10 that shows cams 15 (one of which has been omitted for clarity) for attaching leg member 10 around sleeve member 17 to axle 3.

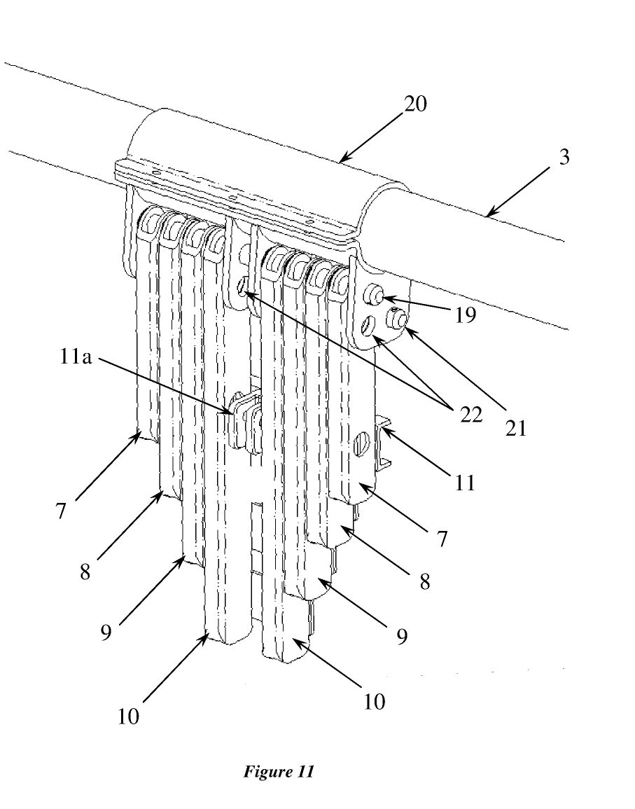

Referring now to FIG. 11 that shows another possible installation method for attaching another possible embodiment to a trailer. Referring still to FIG. 11 that shows leg members 7, 8, 9, and 10 attached to a pivot axis 19 on a bracket 20 that attaches to axle 3. Referring still to FIG. 11 that shows a limiting member 11 that limits the rotation of leg members 7, 8, 9, and 10 about the pivot axis 19. Referring still to FIG. 11 that shows an anchor member 11A attached to limiting member 11 that limits the angle of rotation of leg member 7 about the pivot axis 19. Referring still to FIG. 11 that shows a set of holes 22 in bracket 20 that align with holes in leg members 7, 8, 9, and 10 in which a locking member such as a pin or rod can be inserted when leg members 7, 8, 9, and 10 are fully extended, preventing the rotation of leg members 7, 8, 9, and 10 about the pivot axis 19.

Referring still to FIG. 11 that shows another possible method for limiting the rotation of leg members 7, 8, 9, and 10 about the pivot axis 19. Referring still to FIG. 11 that shows a limiting member 21 that is limiting the rotation of leg members 7, 8, 9, and 10 about the pivot axis 19 when leg members 7, 8, 9, and 10 are fully extended.

The preferred embodiment attaches to a vehicle in such a fashion as to allow a plurality of leg members to rotate relative to one another and about an axis. The geometry of each leg member is such that any lateral forces or loads acting perpendicular to the plane in which the leg member rotates (i.e. loads parallel to the rotation axis) are reacted by the leg member at the attachment to the rotation axis providing lateral stability during the jacking process and when in the fully jacked position. Additionally, the quantity of leg members and the geometry of leg members is such that regardless of the tire inflation condition, whether fully inflated or completely flat, one leg member will always rest against the ground plane at a steep enough angle (grip angle) to create enough downward force through the leg member and to the ground that sufficient static friction between the leg member and the ground will prevent the leg member from sliding relative to the ground such that when the vehicle is translated or moved along the ground plane, the leg member will become “engaged” and be caused to rotate about the axis providing a lifting force to the vehicle. When the vehicle is not in need of being jacked, the device is held in a stowed position such that it is out of the way and provides sufficient ground clearance as the vehicle travels down the road. When it is determined that it is necessary or desirable to jack the vehicle, the leg members are released from their stowed position and allowed to freely rotate about the axis until they come to rest against the ground causing one of the leg members, as a function of the amount of tire inflation, to be located at the appropriate grip angle and become engaged. Once in this “ready to jack” position, the vehicle operator moves the vehicle along to the ground plane. As the vehicle moves relative to the ground along the ground plane, the engaged leg member, located at its grip angle, will begin the jacking process and will begin to lift the vehicle. Once the first engaged leg member is in its fully extended position, its rotation is limited by the limiting member. As the vehicle continues along the ground plane and as each engaged leg member reaches its fully extended position (against the limiting member), each subsequent leg member will in turn be brought to its grip angle and will become engaged, continuing to lift the vehicle. This process continues through as many leg members as are required to bring the vehicle into the fully jacked position (with all leg members against the limiting member and locked in place by the locking member) such that a fully inflated tire is completely off the ground with sufficient clearance to allow changing of the tire.

Although a detailed description of the preferred embodiment has been disclosed, it is understood that other applications and embodiments are possible and that various changes, substitutions, modifications and/or combinations of the embodiment are possible without departing from the spirit of the invention including, but not limited to variations in leg member lengths and shapes, variations in means for locking the legs in the retracted position, variations in means for locking the legs in the extended position, variations in means of preventing leg members from rotating relative to one another, variations in means for attaching to the vehicle, variations in location of attachment to the vehicle (i.e. locations other than vehicle axle) as well as addition of other members, such as but not limited to foot members, spring members and actuating members that may aid in the extension and/or retraction of the leg members or otherwise improve the utility, function and use of the invention.

For each of the described configurations, it is also possible to move the ground plane relative to the vehicle being jacked and achieve the same effect.

Additionally, the vehicle or object being jacked does not have to have wheels for any of the described configurations to work. Similar configurations can be utilized to provide lifting or jacking of objects other than vehicles whether the objects have wheels or not.

What is claimed is:

1. A device for lifting or jacking a vehicle, said device comprising a plurality of leg members of differing lengths that are each free to rotate independently of one another and about an axis or a plurality of axes, said leg members being arranged such that movement of said vehicle relative to a ground plane provides a lifting or jacking force to be imparted on said vehicle by said leg members, and said leg members each being arranged such that they additionally provide a reactive force sufficient to react side loads imparted on said leg members, said side loads acting parallel to said axis or axes.

2. The device of claim 1 wherein said leg members each have a pivotable end that is oriented at a pivot axis and a free end that is oriented away from said pivot axis such that unrestrained, said free end of each said leg member will rotate about said pivot axis and wherein said leg members additionally have:
a. a fully retracted or stowed position in which said free end is oriented away from said ground plane and
b. a fully extended position in which said free end is oriented away from said fully retracted or stowed position and in contact with said ground plane such that a lifting or jacking force is imparted on said vehicle achieving vertical displacement of said vehicle.

3. The device of claim 2 wherein said leg members are restrainable in said fully retracted or stowed position by a restraining member and said leg members are restrainable in said fully extended position by said restraining member or by another restraining member.

4. The device of claim 3 wherein said leg members have lengths in correlation to a vertical lifting or jacking range, said vertical lifting or jacking range being defined by the vertical distance traveled by a reference location on said vehicle (jacking plane) relative to the surface supporting said vehicle (ground plane) during the lifting or jacking process, said vertical distance ranging from a lowest jacking plane position represented by the least vertical distance between said jacking plane and said ground plane and prior to the beginning of said lifting or jacking process and a highest jacking plane position represented by the greatest vertical distance between said jacking plane and said ground plane and subsequent to the completion of said lifting or jacking process, said leg member lengths being established for said lifting or jacking range as follows:
a. a first leg member having a length determined as a function of the vertical distance between said jacking plane and said ground plane when the vehicle wheel, without a tire, is in contact with said ground plane making said ground plane tangent to said vehicle wheel's diameter,
b. a last leg member having a length determined as a function of the vertical distance between said jacking plane and said ground plane when there is sufficient clearance with said ground plane to remove and install said vehicle wheel having a fully inflated tire,
c. optionally, one or more additional leg members each having a length greater than said first leg member length and less than said last leg member length.

5. The device of claim 4 wherein each said leg member length additionally provides for each said leg member to become oriented at a sufficiently steep angle relative to said ground plane such that as said vehicle is moved relative to said ground plane, a sufficient frictional force is generated between said leg member and said ground plane such that said leg member does not slide relative to said ground plane, causing said leg member to rotate about its pivot axis imparting a lifting or jacking force onto said vehicle.

6. The device of claim 5 wherein said leg member lengths are established as follows:
a. A first leg member length established such that when said vehicle is sitting with its wheel, without a tire, in contact with said ground plane, the first leg member is oriented at a sufficiently steep angle relative to said ground plane such that as said vehicle is moved relative to said ground plane, a sufficient frictional force is generated between said first leg member and said ground plane such that said first leg member does not slide relative to said ground plane, causing said first leg member to rotate about its pivot axis imparting a lifting or jacking force onto said vehicle.
b. A last leg member length that is:
i. short enough that as one leg member becomes oriented in its fully extended position, the last leg member is placed at a sufficiently steep angle relative to said ground plane such that as said vehicle moves relative to said ground plane, a sufficient frictional force is generated between said last leg member and said ground plane such that said last leg member does not slide relative to said ground plane, causing said last leg member to rotate about its pivot axis imparting a lifting or jacking force onto said vehicle, and
ii. long enough to provide sufficient lifting or jacking of said vehicle such that sufficient clearance is provided between said vehicle's tire and said ground plane for said vehicle's wheel, with a fully inflated tire, to be removed and installed on said vehicle once said last leg member is in its fully extended position.
c. Optional additional leg member lengths that vary between said first leg member length and said last leg member length, each said additional leg member length being:
i. Short enough that as one leg member becomes oriented in its fully extended position, said additional leg member is placed at a sufficiently steep angle relative to said ground plane such that as said vehicle moves relative to said ground plane, a sufficient force is generated between said additional leg member and said ground plane such that said additional leg member does not slide relative to said ground plane, causing said additional leg member to rotate about its pivot axis imparting a lifting or jacking force onto said vehicle, and
ii. Long enough that as said additional leg member is brought to its fully extended position, it provides sufficient lifting or jacking of said vehicle such that another leg member is placed at a sufficiently steep angle relative to said ground plane such that as said vehicle moves relative to said ground plane, a sufficient frictional force is generated between said other leg member and said ground plane such that said other leg member does not slide relative to said ground plane, causing said other leg member to rotate about its pivot axis imparting a lifting or jacking force onto said vehicle, continuing the lifting or jacking sequence.

7. The device of claim 6 wherein one end of a restraining member, such as a cable, chain, rod or other restraining member, is attached to at least one leg member at some distance away from the pivotable end of said leg member(s) and the opposite end of said restraining member is fixed relative to said vehicle such that as said leg member(s) is positioned in the fully extended position, said restraining member provides a restraining force that prevents rotation of said leg member(s) beyond the fully extended position.

8. The device of claim 7 wherein one or more said leg members additionally have a limiting member that provides a restraining force that prevents rotation of one or more other leg members beyond the fully extended position.

9. The device of claim 6 wherein a mechanical stop member provides a limit to the rotation of one or more said leg members such that as said leg member(s) is positioned in the fully extended position, said mechanical stop member provides a restraining force that prevents rotation of said leg member(s) beyond the fully extended position.

10. The device of claim 9 wherein one or more said leg members additionally have a limiting member that provides a restraining force that prevents rotation of one or more other leg members beyond the fully extended position.

11. The device of claim 6 wherein one end of a restraining member, such as a cable, chain, rod or other restraining member, is attached to at least one leg member at some distance away from the pivotable end of said leg member(s) and the opposite end of said restraining member(s) is fixed relative to said vehicle such that as said leg member(s) is positioned in the fully retracted or stowed position, said restraining member provides a restraining force that prevents rotation of said leg member(s) out of the fully retracted or stowed position.

12. The device of claim 11 wherein one or more said leg members additionally have a limiting member that provides a restraining force that prevents rotation of one or more other leg members out of the fully retracted or stowed position.

13. The device of claim 6 wherein a mechanical stop member provides a limit to the rotation of one or more of the leg members such that as said leg member(s) is positioned in the fully retracted or stowed position, said mechanical stop member provides a restraining force that prevents rotation of said leg member(s) out of the fully retracted or stowed position.

14. The device of claim 13 wherein one or more said leg members additionally have a limiting member that provides a restraining force that prevents rotation of one or more other leg members out of the fully retracted or stowed position.

15. The device of claim 6 wherein one or more spring members are utilized to engage one or more said leg members such that said leg member(s) are forced towards the fully extended position causing an increased force between said leg member(s) and said ground plane and causing increased friction between said leg member(s) and said ground plane.

16. The device of claim 6 wherein said pivot axis of said leg members is the axle of said vehicle, said device additionally having a sleeve member that fits on or around said axle, said leg members fitting on around said sleeve member such that said axle is protected by said sleeve member and said axle is not subjected to relative motion, friction, and rubbing by said leg members directly on said axle during said lifting or jacking process.

17. The device of claim 16 wherein said sleeve member contains a slot, groove or other feature to provide for routing of items such as electrical or hydraulic lines.
